(19) United States
(12) Patent Application Publication
(10) Pub. No.: US 2015/0032912 A1
(43) Pub. Date: Jan. 29, 2015

(54) INFORMATION PROCESSING APPARATUS AND INFORMATION PROCESSING METHOD

(71) Applicant: KABUSHIKI KAISHA TOSHIBA, Tokyo (JP)

(72) Inventors: Takanori Yamaguchi, Hamura-shi (JP); Masami Tanaka, Ome-shi (JP); Hajime Suda, Hamura-shi (JP); Hiroki Yamanaka, Ome-shi (JP); Hideki Miyasato, Yokohama-shi (JP); Zhengzhe Luo, Kokubunji-shi (JP)

(73) Assignee: KABUSHIKI KAISHA TOSHIBA, Tokyo (JP)

(21) Appl. No.: 14/160,970

(22) Filed: Jan. 22, 2014

Related U.S. Application Data
(60) Provisional application No. 61/858,374, filed on Jul. 25, 2013.

(51) Int. Cl. G06F 11/30

(52) U.S. Cl. CPC G06F 11/3062; G06F 11/3065
USPC 710/19

(57) ABSTRACT

According to one embodiment, an information processing apparatus includes a first terminal, a power supply module, a detector, a processor and an output module. The first terminal is configured to connect a cable from a chargeable first external apparatus. The power supply module is configured to supply electric power to the first external apparatus via the first terminal. The detector is configured to detect a power supply status of the power supply module. The processor configured to process first input information from the first external apparatus via the first terminal. The output module is configured to output first unique information of the first external apparatus included in the first input information, and the power supply status detected by the detector.

### CROSS-REFERENCE TO RELATED APPLICATIONS

This application claims the benefit of U.S. Provisional Application No. 61/858,374, filed Jul. 25, 2013, the entire contents of which are incorporated herein by reference.

### FIELD

Embodiments described herein relate generally to an information processing apparatus and information processing method.

### BACKGROUND

Conventionally, electronic apparatuses which can record (video-record) and play back video contents (streams) of movies, television programs, or games have prevailed.

Also, electronic apparatuses which support standards required to transmit streams such as HDMI (High Definition Multimedia Interface)® and MHL (Mobile High-definition Link)® have prevailed.

An electronic apparatus (source) on the stream output side outputs a stream to an electronic apparatus (sink) on the stream receiving side. The sink plays back the received stream, and displays a played-back video on a display. When the source and sink are connected to each other via the MHL, they can mutually operate and control partner apparatuses. Furthermore, the sink can supply electric power to the source via an MHL cable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view for explaining a transmission/reception system according to one embodiment;

FIG. 2A is a block diagram for explaining the transmission/reception system according to one embodiment;

FIG. 2B is a block diagram for explaining the transmission/reception system according to one embodiment;

FIG. 3 is a block diagram for explaining the transmission/reception system according to one embodiment;

FIG. 4 is a block diagram for explaining the transmission/reception system according to one embodiment;

FIG. 5 is a view showing a connection example of a video processing apparatus according to one embodiment, and a single portable terminal;

FIG. 6 is a view showing a connection example of the video processing apparatus according to one embodiment, and a plurality of portable terminals;

FIG. 7 is a view showing an example of a registration change screen displayed by the video processing apparatus; and

FIG. 8 is a flowchart showing an example of display processing of unique information of a portable terminal.

### DETAILED DESCRIPTION

Various embodiments will be described hereinafter with reference to the accompanying drawings.

In general, according to one embodiment, an information processing apparatus includes a first terminal, power supply, detector, processor, and output module. The first terminal is configured to connect a cable from a chargeable first external apparatus. The power supply is configured to supply electric power to the first external apparatus via the first terminal. The detector is configured to detect a power supply status by the power supply. The processor is configured to process first input information from the first external apparatus via the first terminal. The output module is configured to output first unique information of the first external apparatus included in the first input information and the power supply status detected by the detector.

A transmission apparatus, reception apparatus, and transmission/reception system according to one embodiment will be described hereinafter with reference to the drawings.

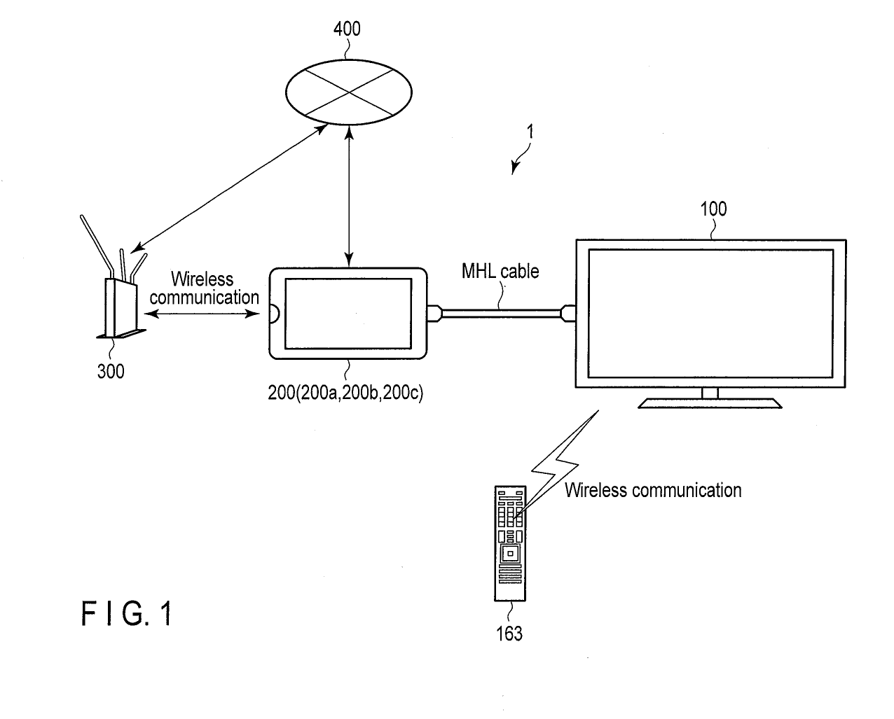

FIG. 1 shows an example of a transmission/receptor system 1 including a plurality of electronic apparatuses. The transmission/receptor system 1 includes, for example, a video processing apparatus 100, portable terminal 200, wireless communication terminal 300, and the like.

The video processing apparatus 100 is an electronic apparatus such as a broadcast receiver, which can play back, for example, broadcast signals or video contents stored in storage media. The video processing apparatus 100 can wirelessly communicate with a remote controller 163.

The portable terminal 200 (external apparatus) is an electronic apparatus including a display, operation unit, and communication unit. The portable terminal 200 is, for example, a mobile phone, tablet PC, mobile music player, game machine, DVD (Digital Versatile Disc) recorder, set-top box, or other electronic apparatuses.

The wireless communication terminal 300 can communicate with the video processing apparatus 100 and portable terminal 200 via wireless or wired communications. That is, the wireless communication terminal 300 functions as an access point of wireless communications. Also the wireless communication terminal 300 can be connected to a network 400 such as an external cloud service. That is, the wireless communication terminal 300 can access the network 400 in response to a request from the video processing apparatus 100 or portable terminal 200. Thus, the video processing apparatus 100 and portable terminal 200 can acquire various data from a server on the network 400 via the wireless communication terminal 300.

The video processing apparatus 100 is connected to the portable terminal 200 via a communication cable compliant with the MHL (MHL cable). The MHL cable has a terminal having a shape compliant with the HDMI standard (HDMI terminal) on one end, and a terminal having a shape compliant with the USB standard (for example, micro USB) (USB terminal) on the other end.

The MHL is the interface standard which can transmit moving image data (stream) including a video and moving image. In the MHL, an electronic apparatus (source) on the stream output side outputs a stream to an electronic apparatus (sink) on the stream reception side via the MHL cable. The sink can play back the received stream, and can display a played-back video on a display. The source and sink can operate and control partner apparatuses by transmitting commands to the apparatuses connected via the MHL cable.

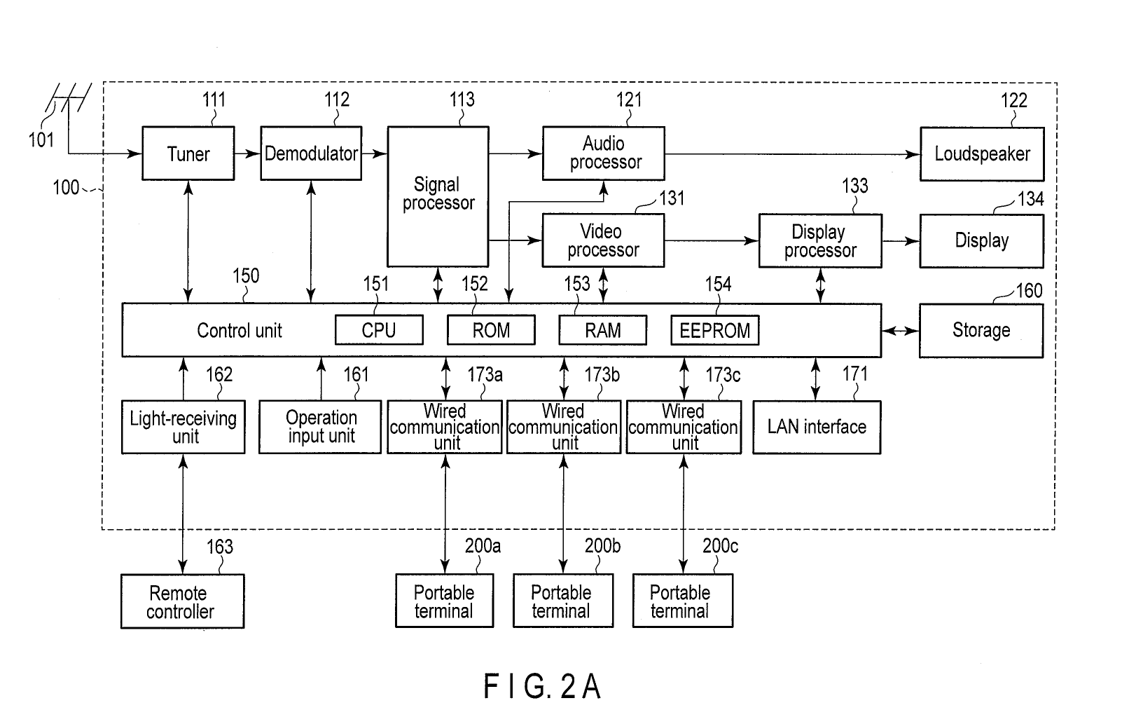

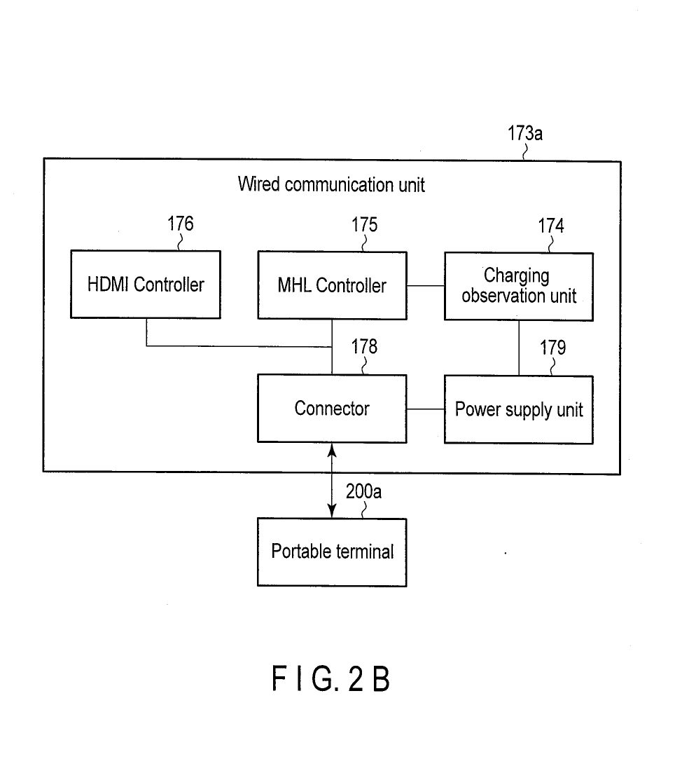

FIG. 2A shows an example of the video processing apparatus 100.

The video processing apparatus 100 is an electronic apparatus such as a broadcast receiver or recorder which can play back, for example, a broadcast signal or video contents stored in a storage medium.

The video processing apparatus 100 includes a tuner 111, demodulator 112, signal processor 113, audio processor 121, video processor 131, display processor 133, control unit 150, storage 160, operation input unit 161, light-receiving unit 162, LAN interface 171, and wired communication units 173a, 173b, and 173c. Also, the video processing apparatus 100 further includes a loudspeaker 122 and display 134.

The tuner 111 can receive a digital broadcast signal received by, for example, an antenna 101. The antenna 101 can receive, for example, a terrestrial digital broadcast signal, BS (Broadcast Satellite) digital broadcast signal, and/or 110° CS (Communication Satellite) digital broadcast signal. The tuner 111 can receive data (streams) of contents such as programs supplied by the digital broadcast signal.

The tuner 111 is that for digital broadcast signals. The tuner 111 tunes the received digital broadcast signal. The tuner 111 transmits the tuned digital broadcast signal to the demodulator 112. Note that the video processing apparatus 100 may include a plurality of tuners 111. The video processing apparatus 100 can simultaneously tune a plurality of broadcast signals using the plurality of tuners.

The demodulator 112 demodulates the received digital broadcast signal. Thus, the demodulator 112 acquires moving image data (to be referred to as a stream hereinafter) such as a transport stream (TS) from the digital broadcast signal. The demodulator 112 inputs the acquired stream to the signal processor 113. Note that the video processing apparatus 100 may include a plurality of demodulators 112. The plurality of demodulators 112 can respectively demodulate a plurality of signals tuned by the plurality of tuners 111.

As described above, the antenna 101, tuner 111, and demodulator 112 function as a reception unit which receives a stream.

The signal processor 113 executes signal processing such as demultiplexing of a stream. That is, the signal processor 113 demultiplexes the stream into a digital video signal, digital audio signal, and other data signals. Note that the signal processor 113 can demultiplex a plurality of streams demodulated by the plurality of demodulators 112. The signal processor 113 supplies the digital audio signal to the audio processor 121. Also, the signal processor 113 supplies the digital video signal to the video processor 131. Furthermore, the signal processor 113 supplies the data signals to the control unit 150.

Also, the signal processor 113 can convert the stream into video-recordable data (video-recordable stream) under the control of the control unit 150. The signal processor 113 can supply the video-recordable stream to the storage 160 or other modules under the control of the control unit 150.

Furthermore, the signal processor 113 can convert (transcode) a bitrate of the stream from an original bitrate to another bitrate. That is, the signal processor 113 can transcode a stream of an original bitrate acquired based on a broadcast signal or the like into that of a lower bitrate. Thus, the signal processor 113 can video-record a content in a capacity-reduced state.

The audio processor 121 converts the digital audio signal received from the signal processor 113 into a signal of a format which can be played back by the loudspeaker 122 (audio signal). For example, the audio processor 121 converts the digital audio signal into an audio signal by digital-to-analog conversion. The audio processor 121 supplies the audio signal to the loudspeaker 122. The loudspeaker 122 plays back a sound based on the supplied audio signal.

The video processor 131 converts the digital video signal received from the signal processor 113 into a video signal of a format which can be played back by the display 134. That is, the video processor 131 decodes (plays back) the digital video signal received from the signal processor 113 into a video signal of a format which can be played back by the display 134. The video processor 131 outputs the video signal to the display processor 133.

The display processor 133 applies, for example, image quality adjustment processing of a color, brightness, sharpness, contrast, and the like to the received video signal under the control of the control unit 150. The display processor 133 supplies the video signal which has undergone the image quality adjustment to the display 134. The display 134 displays a video based on the supplied video signal.

The display 134 includes a liquid crystal display device including a liquid crystal display panel which includes a plurality of pixels arranged in a matrix, and a backlight which illuminates this liquid crystal display panel, and the like. The display 134 displays a video based on the video signal supplied from the display processor 133.

Note that the video processing apparatus 100 may have an arrangement including an output terminal used to output the video signal in place of the display 134. Also, the video processing apparatus 100 may have an arrangement including an output terminal used to output the audio signal in place of the loudspeaker 122. Furthermore, the video processing apparatus 100 may have an arrangement including output terminals used to output the digital video signal and digital audio signal.

The control unit 150 functions as a control unit which controls the operations of the respective units of the video processing apparatus 100. The control unit 150 includes a CPU 151, ROM 152, RAM 153, EEPROM (nonvolatile memory) 154, and the like. The control unit 150 executes various kinds of processing based on operation signals supplied from the operation input unit 161.

The CPU 151 includes an arithmetic element used to execute various kinds of arithmetic processing, and the like. The CPU 151 implements various functions by executing programs stored in the ROM 152, EEPROM 154, or the like.

The ROM 152 stores programs required to control the video processing apparatus 100, those required to implement various functions, and the like. The CPU 151 launches a program stored in the ROM 152 based on an operation signal supplied from the operation input unit 161. Thus, the control unit 150 controls the operations of the respective units.

The RAM 153 functions as a work memory of the CPU 151. That is, the RAM 153 stores arithmetic results of the CPU 151, data loaded by the CPU 151, and the like.

The EEPROM 154 is a nonvolatile memory which stores various kinds of setting information, programs, and the like.

The storage 160 has a storage medium which stores contents. For example, the storage 160 is configured by an HDD (Hard Disk Drive), SSD (Solid State Drive), semiconductor memory, or the like. The storage 160 can store the video-recordable stream supplied from the signal processor 113.

The operation input unit 161 includes, for example, operation keys, a touch pad, or the like used to generate operation signals in response to operation inputs by the user. The operation input unit 161 may have an arrangement which receives operation signals from a keyboard, mouse, or other input devices which can generate operation signals. The operation input unit 161 supplies operation signals to the control unit 150.

Note that the touch pad includes a device which generates position information based on a capacitance sensor, thermo sensor, or other systems. When the video processing apparatus 100 includes the display 134, the operation input unit 161 may include a touch panel formed integrally with the display 134.

The light-receiving unit 162 includes, for example, a sensor which receives an operation signal from the remote controller 163, and the like. The light-receiving unit 162 supplies the received signal to the control unit 150. The control unit 150 receives the signal supplied from the light-receiving unit 162, and amplifies and A/D-converts the received signal, thus decoding an original operation signal transmitted from the remote controller 163.

The remote controller 163 generates an operation signal based on an operation input of the user. The remote controller 163 transmits the generated operation signal to the light-receiving unit 162 via infrared communications. Note that the light-receiving unit 162 and remote controller 163 may exchange operation signals via other wireless communications such as radio waves.

The LAN interface 171 can communicate with other apparatuses on the network 400 via a LAN or wireless LAN and the wireless communication terminal 300. Thus, the video processing apparatus 100 can communicate with other apparatuses connected to the wireless communication terminal 300. For example, the video processing apparatus 100 can acquire and play back a stream recorded in an apparatus on the network 400 via the LAN interface 171.

The wired communication units 173a, 173b, and 173c have the same basic arrangement. As shown in FIG. 2B, the wired communication unit 173a is an interface which makes communications based on the standards such as HDMI and MHL. The wired communication unit 173a includes a connector (HDMI/MHL terminal) 178, which can connect an HDMI cable or can also connect an MHL cable in place of the HDMI cable. Furthermore, the wired communication unit 173a includes an HDMI controller 176 which processes a signal from an external apparatus connected via the HDMI cable and connector 178, based on the HDMI standard, and an MHL controller 175 which processes a signal from an external apparatus (portable terminal 200a) connected via the MHL cable and connector 178, based on the MHL standard. Furthermore, the wired communication unit 173a includes a power supply unit 179 which supplies electric power to an external apparatus (portable terminal 200a) connected via the MHL cable and connector 178. Moreover, the wired communication unit 173a includes a charging observation unit 174 which measures a supplied power amount by the power supply unit 179.

Note that according to the above description, each of the wired communication units 173a, 173b, and 173c includes the HDMI controller 176. For example, the wired communication units 173a, 173b, and 173c may selectively use one HDMI controller 176. Also, this embodiment handles the portable terminal 200 and a portable terminal 200a as practically the same terminal.

A terminal of the MHL cable on the side connected to the video processing apparatus 100 includes a structure having compatibility with the HDMI cable. Note that in the MHL cable, a resistor is connected between terminals (detection terminals) which are not used in a communication. Each wired communication unit 173 can recognize whether an MHL is connected or HDMI cable is connected to the HDMI/MHL terminal by applying a voltage to the detection terminals.

The video processing apparatus 100 can receive and play back a stream output from an apparatus (source) connected to the HDMI/MHL terminal of each wired communication unit 173.

The control unit 150 controls to input the stream received by the wired communication unit 173 to the signal processor 113. The signal processor 113 demultiplexes a digital video signal, digital audio signal, and the like from the received stream. The signal processor 113 transmits the demultiplexed digital video signal to the video processor 131, and the demultiplexed digital audio signal to the audio processor 121. Thus, the video processing apparatus 100 can play back the stream received by the wired communication unit 173.

The video processing apparatus 100 includes a power source unit (not shown). The power source unit receives electric power from a commercial power source via an AC adapter and the like. The power source unit converts the received AC electric power into DC power, and supplies the DC power to the respective units in the video processing apparatus 100.

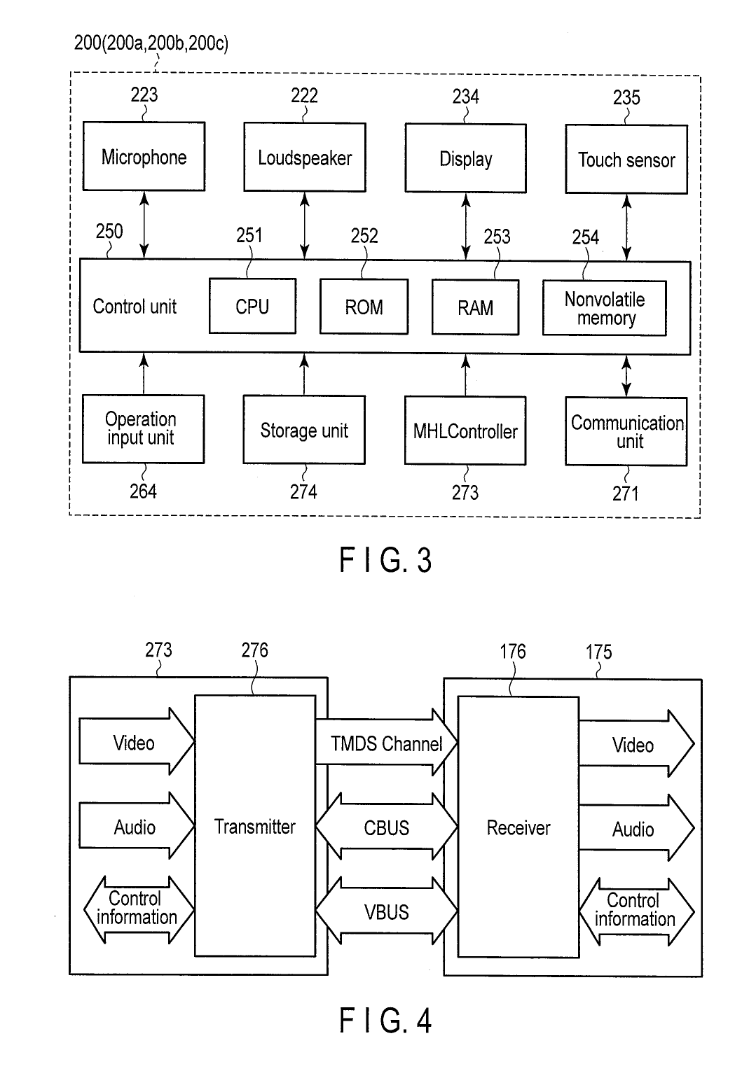

FIG. 3 shows an example of the portable terminal 200 (200a, 200b, 200c) according to one embodiment.

The portable terminal 200 includes a control unit 250, operation input unit 264, communication unit 271, MHL controller 273, and storage device 274. Furthermore, the portable terminal 200 includes a loudspeaker 222, microphone 223, display 234, and touch sensor 235.

The control unit 250 functions as a control unit which controls operations of respective units of the portable terminal 200. The control unit 250 includes a CPU 251, ROM 252, RAM 253, nonvolatile memory 254, and the like. The control unit 250 executes various kinds of processing based on operation signals supplied from the operation input unit 264 or touch sensor 235.

The CPU 251 includes an arithmetic element used to execute various kinds of arithmetic processing, and the like. The CPU 251 implements various functions by executing programs stored in the ROM 252, nonvolatile memory 254, or the like.

The ROM 252 stores programs required to control the portable terminal 200, those required to implement various functions, and the like. The CPU 251 launches a program stored in the ROM 252 based on an operation signal supplied from the operation input unit 264. Thus, the control unit 250 controls the operations of the respective units.

The RAM 253 functions as a work memory of the CPU 251. That is, the RAM 253 stores arithmetic results of the CPU 251, data loaded by the CPU 251, and the like.

The nonvolatile memory 254 stores various kinds of setting information, programs, and the like.

The CPU 251 can execute various kinds of processing based on data such as applications stored in the storage device 274.

Also, the control unit 250 can generate video signals to be displayed of various screens and the like in accordance with applications executed by the CPU 251, and can display the screens on the display 234. Furthermore, the control unit 250 can generate audio signals to be played back of various sounds in accordance with applications executed by the CPU 251, and can output the sounds from the loudspeaker 222.

The loudspeaker 222 plays back a sound based on a supplied audio signal.

The microphone 223 is a sound collecting unit which generates a signal (sound recording signal) based on an external sound of the portable terminal 200. The microphone 223 supplies a sound recording signal to the control unit 250.

The display 234 includes a liquid crystal display device including a liquid crystal display panel which includes a plurality of pixels arranged in a matrix, and a backlight which illuminates this liquid crystal display panel, and the like. The display 234 displays a video based on a video signal.

The touch sensor 235 is a device which generates position information based on a capacitance sensor, thermo sensor, or other systems. For example, the touch sensor 235 is integrally arranged on the display 234. Thus, the touch sensor 235 can generate an operation signal based on an operation on the screen displayed on the display 234, and can supply the operation signal to the control unit 250.

Note that the control unit 250 shifts to a lock state (screen lock) when an operation is not input for a predetermined time period or longer, so as to prevent the touch sensor 235 from being erroneously operated. In the lock state, the portable terminal 200 restricts some operation inputs. For example, in the lock state, the portable terminal 200 invalidates operations except for a predetermined operation by the touch sensor 235 and those except for a predetermined operation by the operation input unit 264.

When a pre-set operation input (unlock operation) is input in the lock state, the portable terminal 200 unlocks the lock state. For example, in the lock state, the portable terminal 200 accepts only a pre-set operation input by the operation input unit 264 or touch sensor 235.

The operation input unit 264 includes, for example, keys used to generate operation signals according to operation inputs by the user. The operation input unit 264 includes, for example, a volume adjustment key used to adjust a volume, a luminance adjustment key used to adjust a display luminance level of the display 234, a power key used to switch a power supply state of the portable terminal 200, and the like. Also, the operation input unit 264 may further include a track ball which allows the portable terminal 200 to execute various selection operations and the like. The operation input unit 264 generates an operation signal according to the key operation, and supplies the operation signal to the control unit 250.

The operation input unit 264 may have an arrangement which inputs operation signals from a keyboard, mouse, or other input devices which can generate operation signals. For example, when the portable terminal 200 includes a USB terminal, a Bluetooth® module, or the like, the operation input unit 264 receives an operation signal from an input device connected via USB or Bluetooth, and supplies the operation signal to the control unit 250.

The communication unit 271 can communicate with other apparatuses on the network 400 via a LAN or wireless LAN and the wireless communication terminal 300. Also, the communication unit 271 can communicate with other apparatuses on the network 400 via a mobile phone network. Thus, the portable terminal 200 can communicate with other apparatuses connected to the wireless communication terminal 300. For example, the portable terminal 200 can acquire and play back a moving image, photo, music data, WEB content, and the like recorded in an apparatus on the network 400 via the communication unit 271.

The MHL controller 273 is an interface which makes communications based on the MHL standard. The MHL controller 273 executes signal processing based on the MHL standard. Also, the MHL controller 273 has a USB terminal (not shown) which can receive an MHL cable.

The portable terminal 200 can output a stream to an apparatus (sink) connected to the USB terminal of the MHL controller 273.

Furthermore, the MHL controller 273 can generate a stream by multiplexing a video signal to be displayed and an audio signal to be played back.

For example, when the MHL cable is connected to the USB terminal of the MHL controller 273, and the portable terminal 200 operates as a source, the control unit 250 supplies video signal to be displayed and an audio signal to be played back to the MHL controller 273. The MHL controller 273 can generate a stream of various formats (for example, 1080i, 60 Hz) using the video signal to be displayed and audio signal to be played back. The control unit 250 can output the generated stream to the sink connected to the USB terminal.

The portable terminal 200 includes a power source unit (not shown). The power source unit includes a battery, and a terminal (for example, a DC jack) used to connect an adapter which receives electric power from a commercial power source. The power source unit charges the battery by electric power received from the commercial power source. Also, the power source unit supplies electric power charged on the battery to respective units in the portable terminal 200.

The storage device 274 includes an HDD (Hard Disk Drive), SSD (Solid State Drive), semiconductor memory, or the like. The storage device 274 can store programs to be executed by the CPU 251 of the control unit 250, applications, contents such as moving images, various data, and the like.

FIG. 4 shows a communication example based on the MHL standard. Note that this embodiment will explain the portable terminal 200 as a source and the video processing apparatus 100 as a sink.

The MHL controller 273 of the portable terminal 200 includes a transmitter 276 and a receiver (not shown). The MHL controller 175 of the video processing apparatus 100 includes a transmitter (not shown) and a receiver 176.

The transmitter 276 and receiver 176 are connected via an MHL cable. The MHL line includes lines VBUS, GND, CBUS, MHL+, MHL−, and the like.

The line VBUS is used to transmit electric power. For example, the sink supplies electric power of +5 V to the source via the line VBUS. The source can operate using electric power supplied from the sink via the line VBUS. For example, the power source unit of the portable terminal 200 as the source can charge the battery by electric power supplied from the sink via the line VBUS. The line GND is grounded.

The line CBUS is used to transmit, for example, a control signal such as a command. The line CBUS is used to transmit, for example, a DDC (Display Data Channel) command, MSC (MHL Sideband Channel) command, or the like in two ways. The DDC command is used to read out EDID (Extended Display Identification Data), in HDCP (High-bandwidth Digital Content Protection) authentication, and so forth. The EDID is a list of display information, which is set in advance according to the specification of the display or the like. The MSC command is used in read/write control of various registers (not shown), remote controller control, and so forth.

For example, the video processing apparatus 100 as the sink outputs commands to the portable terminal 200 as the source via the line CBUS. The portable terminal 200 can execute various kinds of processing according to the received commands.

The source transmits the DDC command to the sink to execute HDCP authentication with the sink, and can read out the EDID from the sink.

The HDCP is an encryption method of signals transmitted between the apparatuses. The video processing apparatus 100 and portable terminal 200 exchange keys and the like in the sequence compliant with the HDCP, thus attaining mutual authentication.

Note that the portable terminal 200 may have an arrangement which acquires EDID from the video processing apparatus 100 not during the HDCP authentication but at another timing.

The portable terminal 200 analyzes the EDID acquired from the video processing apparatus 100, and recognizes display information indicating a format including a resolution, color depth, transmission frequency, and the like, which can be processed by the video processing apparatus 100. The portable terminal 200 generates a stream in the format including the resolution, color depth, transmission frequency, and the like, which can be processed by the video processing apparatus 100.

The lines MHL+ and MHL− are used to transmit data. The two lines MHL+ and MHL− function as one twist pair line. For example, the lines MHL+ and MHL− function as a TMDS channel used to transmit data based on a TMDS (Transition Minimized Differential Signaling) method. The lines MHL+ and MHL− can transmit a sync signal (MHL clock) of the TMDS method.

For example, the source can output a stream to the sink via the TMDS channel. That is, the portable terminal 200, which functions as the source, can transmit a stream obtained by converting video data (display screen) displayed on the display 234 and audio data output from the loudspeaker 222 to the video processing apparatus 100 as the sink. The video processing apparatus 100 receives the transmitted stream via the TMDS channel, and applies signal processing to the received stream, and plays back the processed stream.

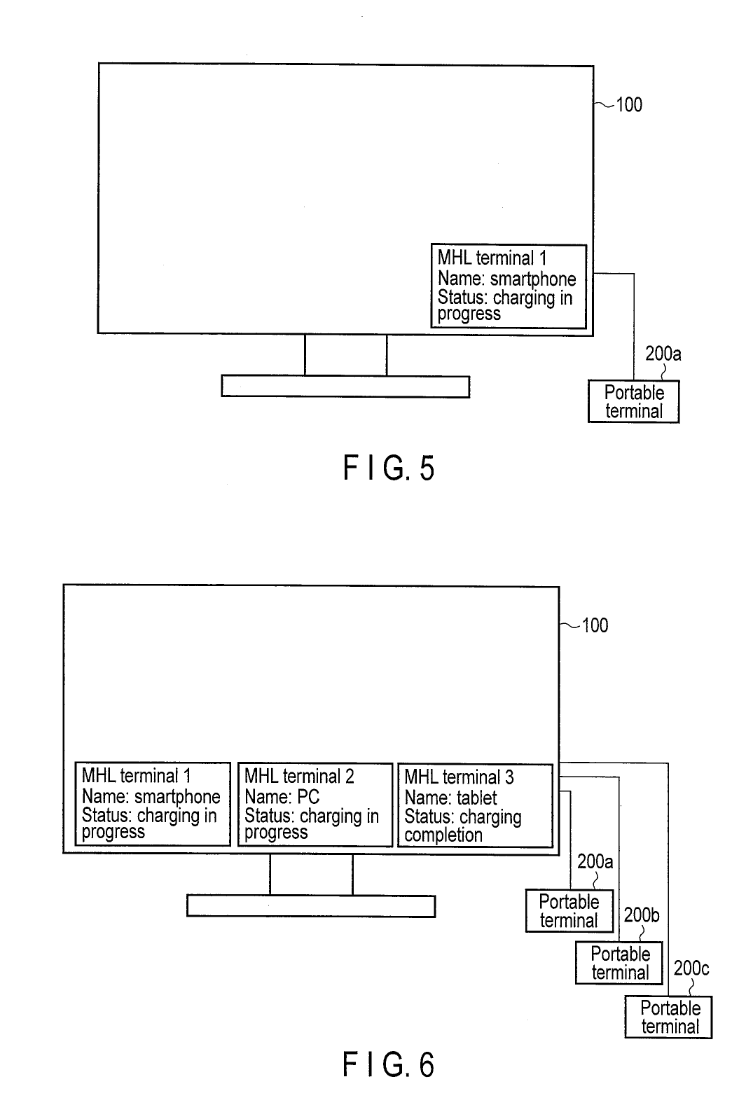

FIG. 5 is a view showing a connection example of the video processing apparatus 100 according to one embodiment and the portable terminal 200a (for example, a smartphone). FIG. 6 is a view showing a connection example of the video processing apparatus 100 according to one embodiment, a portable terminal 200a (for example, a smartphone), a portable terminal 200b (for example, a personal computer), and a portable terminal 200c (for example, a tablet type electronic apparatus).

For example, the connector 178 of the wired communication unit 173a of the video processing apparatus 100 is configured to connect a cable from the chargeable portable terminal 200a. When the connector 178 and a connector of the cable from the portable terminal 200a are connected, the MHL controller 175 detects this connection, and the power supply unit 179 begins to supply electric power, thus supplying electric power to the portable terminal 200a via the connector 178. Also, the MHL controller 175 processes input information from the portable terminal 200a via the connector 178, and transfers unique information (for example, a model number of the apparatus or an apparatus name registered by the user) of the portable terminal 200a included in the input information to the video processor 131. For example, the video processor 131 and display processor 133 superimpose a video indicating the unique information on a video of a content, and the display 134 outputs (displays) the video indicating the unique information together with that of the content.

The charging observation unit 174 detects a power supply status by the power supply unit 179. The MHL controller 175 transfers the power supply status to the video processor 131. For example, the video processor 131 and display processor 133 superimpose a video indicating the unique information and power supply status on a video of a content, and the display 134 outputs (displays) the video indicating the unique information and power supply status together with that of the content. Furthermore, for example, the charging observation unit 174 measures a supplied power amount by the power supply unit 179, and predicts a charging status of the portable terminal 200a based on the measurement result. The MHL controller 175 transfers the charging status (prediction) to the video processor 131. For example, the video processor 131 and display processor 133 superimpose a video indicating the unique information and charging status on a video of a content, and the display 134 outputs (displays) the video indicating the unique information and charging status together with that of the content. FIG. 5 shows an output example of the video indicating the unique information and charging status.

For example, the video processing apparatus 100 (display 134) can display the unique information of the portable terminal 200a and can display the charging status together with the unique information during a charging period of the portable terminal 200a.

Also, when the video processing apparatus 100 is connected to a plurality of portable terminals, it can display corresponding pieces of unique information of the respective portable terminals, and can display the corresponding pieces unique information and charging statuses of the respective portable terminals. FIG. 6 shows an output example of videos each indicating the unique information and charging status when the video processing apparatus is connected to the plurality of portable terminals. Furthermore, when the video processing apparatus 100 is connected to a plurality of portable terminals, it can display unique information of the portable terminal during a charging period of the plurality of portable terminals, and can display the unique information and a charging status of the portable terminal during the charging period.

The charging status will be supplemented below.

The power supply unit 179 shown in FIG. 2B supplies electric power to the portable terminal 200a connected via the MHL cable and connector 178. The charging observation unit 174 observes (measures) a supplied power amount (supplied current amount) by the power supply unit 179. The charging observation unit 174 measures (detects) a change in supplied power amount along with the elapse of time, predicts a charging status of the portable terminal 200 based on the measurement result of the supplied power amount, and generates a charging status guide related to the charging status (prediction). The MHL controller 175 transfers the charging status guide to the video processor 131. For example, the video processor 131 and display processor 133 superimpose a video indicating unique information and the charging status guide on a video of a content, and the display 134 outputs (displays) the video indicating the unique information and charging status guide together with that of the content.

For example, the charging status guide includes “charging in progress”, “charging completion”, “recharging in progress”, “charging disabled”, “charging interrupted”, and the like, and their details are as follows.

Charging in progress: Power supply to an external apparatus is currently in progress via the connector.

Charging completion: After an external apparatus was connected to the connector, electric power was supplied to the external apparatus via the connector, and the external apparatus is currently connected via the connector, but no electric power is supplied.

Recharging in progress: After an external apparatus was connected to the connector, electric power was supplied to the external apparatus via the connector, and power supply is in progress again via a non-power supply status.

Charging disabled: After an external apparatus was connected to the connector, electric power of a predetermined amount or more cannot be supplied even after the elapse of a predetermined time period.

Charging interrupted: After an external apparatus was connected to the connector, power supply to the external apparatus was interrupted after observation of power supply of a predetermined amount or more.

Furthermore, the control unit 150 may control to predict a further charging status using at least one of the stored previous current, electric power, power amount, and charging status, to calculate a prediction time until the status “charging completion”, and to output (display) the calculated prediction time (charging completion prediction time).

The unique information of the portable terminal 200a will be described below. The nonvolatile memory 254 of the portable terminal 200a stores, for example, a model number as first unique information. Furthermore, the nonvolatile memory 254 stores, for example, a registered name (name) as second unique information. The first unique information is information set before shipping of the portable terminal 200a. The second unique information is information set by the user after shipping of the portable terminal 200a. The user can register the second unique information via the operation input unit 264 of the portable terminal 200a. Also, as will be described later, the user can register the second unique information in the portable terminal 200a via the video processing apparatus 100 to which the portable terminal 200a is connected.

The portable terminal 200a is connected to the video processing apparatus 100, and can transmit the first unique information to the video processing apparatus 100, can transmit the second unique information to the video processing apparatus 100, or can transmit only the first unique information and second unique information to the video processing apparatus 100. Thus, the video processing apparatus 100 can display the first unique information, can display the second unique information, or can display the first unique information and second unique information in response to connection of the portable terminal 200a.

A registration change example of the second unique information will be described below.

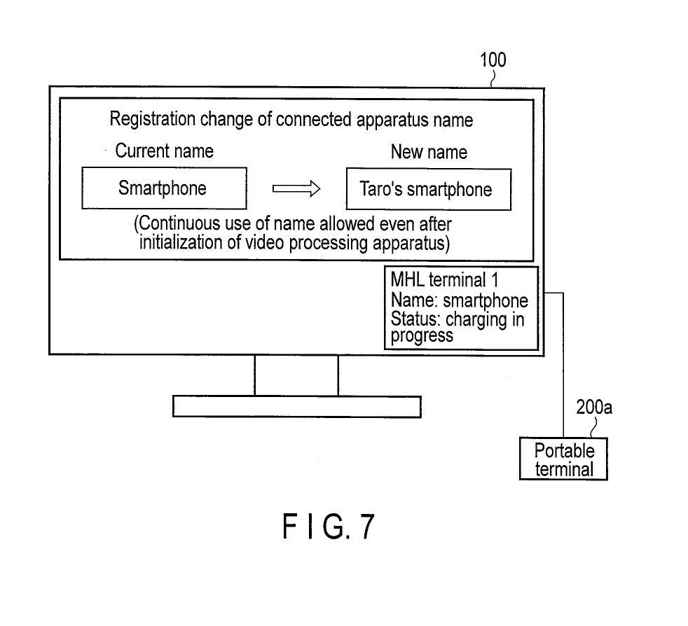

FIG. 7 shows an example of a registration change screen displayed by the video processing apparatus 100. When the user inputs a registration change instruction of unique information via the remote controller 163 or the like, the video processing apparatus 100 (display 134) displays the registration change screen shown in FIG. 7. For example, the registration change screen displays the current second unique information (for example, “smartphone” of the portable terminal 200a, and also displays an input field of new second unique information of the portable terminal 200a. The user inputs and registers new second unique information (“Taro's smartphone”) in the input field via the remote controller 163 or the like.

The MHL controller 175 transmits the new second unique information to the portable terminal 200a via the connector 178. The portable terminal 200a receives the new second unique information via the communication unit 271, and updates the current second unique information stored in the nonvolatile memory 254 to the new second unique information. Thus, the portable terminal 200a transmits the updated new second unique information as the second unique information in subsequent connections.

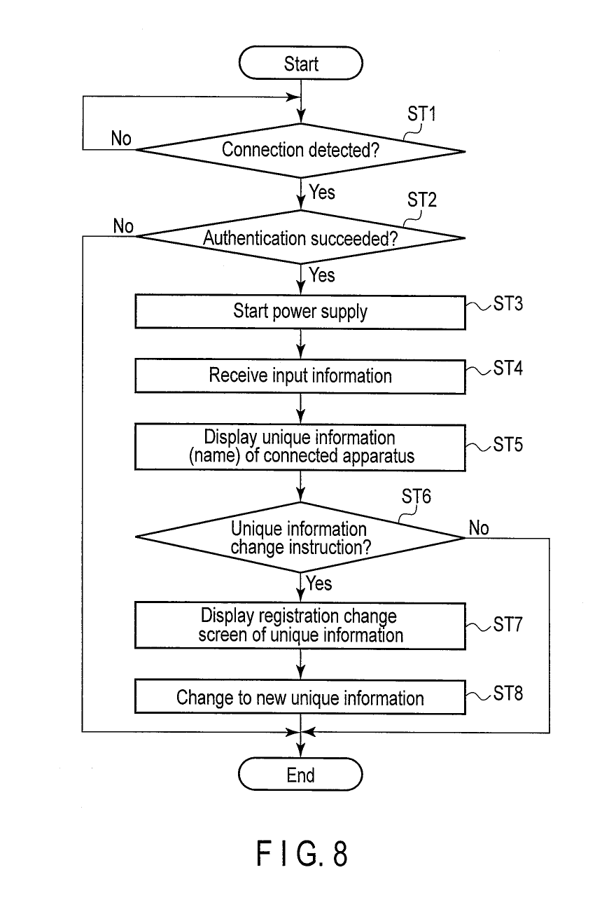

FIG. 8 is a flowchart showing an example of display processing of unique information of the portable terminal.

When the connector 178 of the wired communication unit 173a of the video processing apparatus 100 is connected to a connector of a cable from the chargeable portable terminal 200a, the MHL controller 175 detects this connection (YES in step ST1), and authenticates the portable terminal 200a. If the authentication has succeeded (YES in step ST2), the power supply unit 179 begins to supply electric power (step ST3), and electric power is supplied to the portable terminal 200a via the connector 178. The MHL controller 175 receives input information from the portable terminal 200a via the connector 178 (step ST4), and transfers unique information (for example, a model number of the apparatus or an apparatus name registered by the user) of the portable terminal 200a included in the input information to the video processor 131. For example, the video processor 131 and display processor 133 superimpose a video indicating the unique information on a video of a content, and the display 134 outputs (displays) the video indicating the unique information together with that of the content (step ST5).

For example, when the user inputs a registration change instruction of unique information via the remote controller 163 or the like (YES in step ST6), the video processing apparatus 100 (display 134) displays the registration change screen (step ST7). The user can change the current second unique information (for example, “smartphone”) of the portable terminal 200a to new second unique information (“Taro's smartphone) via the registration change screen (YES in step ST8). The portable terminal 200a stores the new second unique information.

After that, when the video processing apparatus 100 is disconnected from the portable terminal 200a, and another video processing apparatus 100 is connected to the portable terminal 200a, the other video processing apparatus 100 can receive and display the new second unique information transmitted from the portable terminal 200a.

This embodiment will be summarized below.

Since the video processing apparatus displays a charging status together with unique information of the connected portable terminal, the user can easily recognize the status by merely watching the display of the video processing apparatus (by continuously viewing a content or the like) without checking the portable terminal side. Furthermore, when the video processing apparatus is connected to a plurality of portable terminals, since it displays charging statuses of the respective terminals together with corresponding pieces of unique information of the respective terminals, the user can recognize statuses in detail.

The portable terminal holds unique information (changed second unique information or the like). Hence, even after the video processing apparatus is initialized, when the video processing apparatus and portable terminal are connected, the video processing apparatus can display the unique information of the portable terminal. Also, even when another video processing apparatus is connected to the portable terminal, that apparatus can display the unique information of the portable terminal.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first terminal configured to connect to a chargeable first external apparatus through a cable;
a power supply configured to supply electric power to the first external apparatus via the first terminal;
a detector configured to detect a power supply status of the power supply;
a processor configured to process first input information from the first external apparatus via the first terminal; and
an output controller configured to output first unique information of the first external apparatus included in the first input information, and the power supply status detected by the detector.

2. The apparatus of claim 1, further comprising an interface configured to receive a name of the first external apparatus,
wherein the processor is configured to transmit the name to the first external apparatus via the first terminal configured to register the name in the first external apparatus, and
the output controller is configured to output the name included in the first input information transmitted from the first external apparatus.

3. The apparatus of claim 1, further comprising a second terminal configured to connect to a chargeable second external apparatus through a cable,
wherein the power supply is configured to supply electric power to the second external apparatus via the second terminal,
the processor is configured to process second input information input via the second terminal, and
the output controller is configured to output second unique information of the second external apparatus included in the second input information.

4. The apparatus of claim 1, wherein the first terminal is configured to connect to the apparatus through an MHL cable compliant with an MHL standard.

5. The apparatus of claim 1, wherein the detector is configured to detect a change in supplied power amount along with an elapse of time.

6. An information processing method comprising:
supplying electric power to a chargeable external apparatus via a terminal connected to the external apparatus through a cable;
detecting a power supply status of the external apparatus; and
outputting unique information of the external apparatus included in input information from the external apparatus via the terminal, and the detected power supply status.
